(19) United States
(12) Patent Application Publication
(10) Pub. No.: US 2008/0050518 A1
(43) Pub. Date: Feb. 28, 2008

(54) Device and Method for Coating Tablets by Means of One Rotatable Drum

(75) Inventor: Hans-Hermann Juergens, Paderborn (DE)

Correspondence Address: BARNES & THORNBURG LLP, 11 SOUTH MERIDIAN, INDIANAPOLIS, IN, 46204, US

(73) Assignee: Gebr. Lodige Maschinenbau-GmbH, Paderborn (DE)

(21) Appl. No.: 11/628,785

(22) PCT Filed: Mar. 2, 2005
(86) PCT No.: PCT/EP05/50915

§ 371 Date: Dec. 6, 2006

(30) Foreign Application Priority Data
Jun. 17, 2004 (EP) 04102777.2

(51) Int. Cl. B05B 13/02

(52) U.S. Cl. 427/242; 118/418; 118/50

(57) ABSTRACT

The invention relates to a tablet coating device and method.

The invention relates to a tablet coating device and method.

A tablet coating device comprising a drum is commercially available. The drum has perforated segments. The drum is mounted horizontally. It can be rotated about a horizontal axis. The drum has an opening for emptying and a door. The tablets are put into the drum through the door. The tablets are coated in the drum. The coated tablets are taken out through the opening for emptying.

The door is fastened laterally or on one end face of the drum. This side will hereinafter be referred to as the front side. The opening for emptying can be located in the circumference of the drum. If the opening for emptying is located at the bottom, the coated tablets can be removed through this opening due to gravity.

In another commercially available embodiment of the invention, there is a special mixer in the interior of the drum. It is made such that the tablets located in the drum are conveyed towards the front side in the case of a rotation in a direction opposite to the direction of rotation during mixing or coating.

Looking from the front side, the material to be coated, which is to be coated, is introduced into the drum via a first feed. Air is introduced into the interior of the drum via a second feed. Aqueous suspensions or paints, or suspensions or paints provided with organic solvents, are brought into the interior of the mixing container via the first feed. In the interior, the suspension is discharged from at least one nozzle. The nozzle is made such that the suspension is nebulized in the interior of the drum. Thus, the suspension thus reaches the tablets in a nebulized form. The mixing container is slowly rotated about the horizontal axis in the process. The drum typically rotates at up to 25 revolutions per minute.

At the same time, or cyclically, conditioned air (of a certain temperature, dried, filtered) is introduced into the interior of the mixing drum. The air, which is heated, is discharged uniformly via a punched sheet. It is the primary object of the air stream is to dry the paint or suspension hitting the tablet. For this purpose, the punched sheet in the state of the art is arranged above the nozzle and such as to face in the same direction as the nozzle. By this arrangement, it is achieved that the air stream flows uniformly in the direction of the material to be mixed, i.e., in the direction of the product, that is, the tablets. The nebulized suspension is also transported in the direction of the product in the process. A suspension thus reaches the tablets particularly reliably.

The air stream is discharged again through the perforation of the drum segments. In the art, the perforation is distributed over the circumference of the drum in one embodiment. They are four equally large segments.

The nozzle is directed downwardly. Thus, the suspension is discharged directly towards the material to be mixed from the first feed. The air stream is discharged into the same direction. Thus, the punched sheet is arranged in accordance with this purpose.

The device described is sold commercially by the Applicant.

In the medical field, there is also the problem that product may only be produced with those machines that have been documented and validated within the context of an approval procedure. If the machine is modified, a notifiable modification procedure is required in order to be allowed to produce the tablets with the modified machine in accordance with the approval. This entails significant effort and costs.

It is the object of the invention to simplify the coating of tablets.

The object of the invention is achieved by a device having the features of the first claim. Advantageous embodiments follow from the dependent claims. An advantageous method is protected in the alternative independent claim.

According to the invention, and in contrast to the above-described state of the art, the suspension is now fed to the drum laterally via a first side, and the air is fed laterally at the opposite side. Thus, the suspension is, for example, fed via the front side, and the air via the rear. In this manner it is accomplished that there is more room at the side from which the operation is carried out by the user. This room is of particular interest to the user of the machine during production. Production processes can thus be simplified, improved and/or made cheaper. The constructional effort is also smaller. Thus, this results in, inter alia, cost advantages in production.

The suspension is preferably fed from the front side. The feed as well the nozzle, via which the suspension is fed, must be cleaned from time to time. It is therefore advantageous to provide this feed from the front side, i.e. from the side of the operator. This reduces the cleaning effort. There is no or significantly less cleaning effort involved for the air feed. Therefore, the air feed is preferably carried out from the rear, which is comparatively hard to access.

In an advantageous embodiment of the invention, the suspension is fed to the drum below or at the level of the axis of rotation. The air is fed to the drum entirely or predominantly above the axis of rotation. Thus, coming from above, the air can be directed towards the material to be mixed and it can transport the nebulized suspension towards the material to be mixed or the tablets in the process. Because the material to be mixed, that is, the tablets, roll in the interior of the drum, they are, on average, not located at the lowest point during the coating, but slightly displaced laterally from this lowest point, depending on the speed of rotation of the drum. Advantageously, this is taken into account when arranging the feeds of air and suspension by the means for feeding air and suspension being oriented so that the suspension as well as the air are guided in the direction of this laterally displaced point. If a punched plate and a nozzle are used as feeding means, the punched plate as well as the nozzle are oriented not exactly vertically, but correspondingly obliquely. The punched plate is then approximately oriented to be parallel to the surface that the tablets form during coating. In that case, air and suspension are discharged in the same direction from the respective feeding means. The direction of discharge of air and suspension then enclose an angle with the vertical that is larger than 0° and smaller than 90°. As a rule, this angle is between 10° and 60°, in particular between 25° to 50°, at the common speeds of rotation of up to 25 revolutions per minute.

In the state of the art, the air was fed to the drum via a ring-shaped recess at the front side. The drum according to the invention advantageously still has this ring-shaped recess at the front side. Now, however, a circular plate, which is rotatably connected to the rest of the drum, is provided at the rear. Advantageously, the rotatable connection is formed to be sealing. During mixing, the drum rotates, and not the circular plate. The air is passed, via an appropriate pipe, through this circular plate. The technical area, for example, the electronic controls, motors etc. of the entire device are then arranged behind the rear of the drum. This technical area is thus separated from the production area, which is also advantageous for a trouble-free operation. Therefore, advantageously, a ring-shaped opening is not also provided in the rear as in the front side in order to thus ensure the shielding of the production area from the technical area.

The sealing connection in the rotatable mounting in general consists of an elastomer or an elastomeric mixture. Advantageously, it is food-safe and, as a rule, suitable for pharmaceutical purposes, depending on the field of application. Silicone is a typical material suitable for the aforementioned purposes.

In an advantageous embodiment, a drum is provided in which only individual segments of the circumference are perforated (partially perforated drum). Further, a drum is provided which is perforated over the entire circumference of the drum (fully perforated drum). The side walls of the two drums are excepted from the perforation for reasons of shielding. Both drums are adapted to the rest of the device so that the respective drum can be used in the entire device depending on the requirements. Thus, different drums can be used with one and the same periphery. This is advantageous for producing different medicines that have been validated, in the one case, with the partially perforated drum, and, in the other case, with the fully perforated drum.

If a fully perforated drum is used, then greater frictional forces occur between the tablets and the drum during the mixing process. Due to the larger frictional forces, the tablets cannot be produced to have such a high gloss, compared with the production in a partially perforated drum.

Mixing apparatuses with a fully perforated drum are used, according to the state of the art, to arrange the air feed outside of the drum. Larger quantities of air are required during the use of such devices with fully perforated drums, which are sold commercially by competitors of the Patentee, in order to produce the desired result. The larger air feed poses problems because the air needs to be warmed up. Thus, more heat energy must, correspondingly, be used. Accordingly, this results in disadvantages with regard to cost in the case of production by means of a fully perforated drum known from the state of the art.

The larger air quantity also results in a larger quantity of suspension being undesirably transported out of the drum. Thus, suspension is lost without having been used. The suspension that has been transported outside also cannot be fed back again, because it has already dried too much then. This also results in disadvantages regarding costs.

By also having provided a fully perforated drum with an air feed or an air feed shoe, the quantity of air needed can be successfully reduced to a significant extent, compared with the state of the art. Thus, cost advantages result with regard to coating tablets compared with the state of the art with the fully perforated drums.

A typical diameter of a drum according to the invention is between 25 cm to 1.70 m. The width or depth of the drum is typically between 30 cm to 1.50 m. The utilizable volume of the drum typically is 1 to 1000 I. A utilizable volume is the volume suitable for receiving the tablets. In the case of a drum with a ring-shaped opening, for example, this utilizable volume extends up to this opening.

Advantageously, a suction device bordering on the drum is provided underneath the drum, and in particular in the case of the fully perforated drum. In a simple embodiment, this suction device has a box-shaped opening through which air is sucked out of the drum. The box-shaped opening or the upper border of this opening borders as closely as possible on the drum. The border is advantageously provided with a sealing lip in order to provide suction particularly reliably in the desired manner. In another embodiment, or additionally, there are castors by the border onto which the drum is placed. These castors support the rotational movement of the drum, and at the same time have the function of providing a seal for the suction device.

What is problematic about the negative pressure created inside the drum by the suction device is that dried suspension, that is, dust, can undesirably escape from the drum into the interior of the device due to the fluctuations of air pressure. In order to counteract this, an air feed serving as a barrier is provided at said border. In one embodiment it may suffice that the air is discharged only at a front side and rear at the border, depending on the seal used. In another embodiment, the air is discharged at all four sides of the border.

The air feed at the border has the function of forming a barrier for the suspension. Thus, no suspension that has been sucked off can come into the interior of the device. This reduces the cleaning costs, because the interior is accordingly soiled less.

During production, the drum is located in a box that is sealed air-tight. This box serves the protection of the environment against escaping dust that was formed by dried suspensions and tablet dust.

In one embodiment, there is a circumferential ring on the front side. The circumferential ring runs on castors while the drum is rotated. The drum is borne at the front in this manner. The ring is sealed from the outside by means of a seal. The closing part is sealed air-tight from the outside in order to shield the production from the outside.

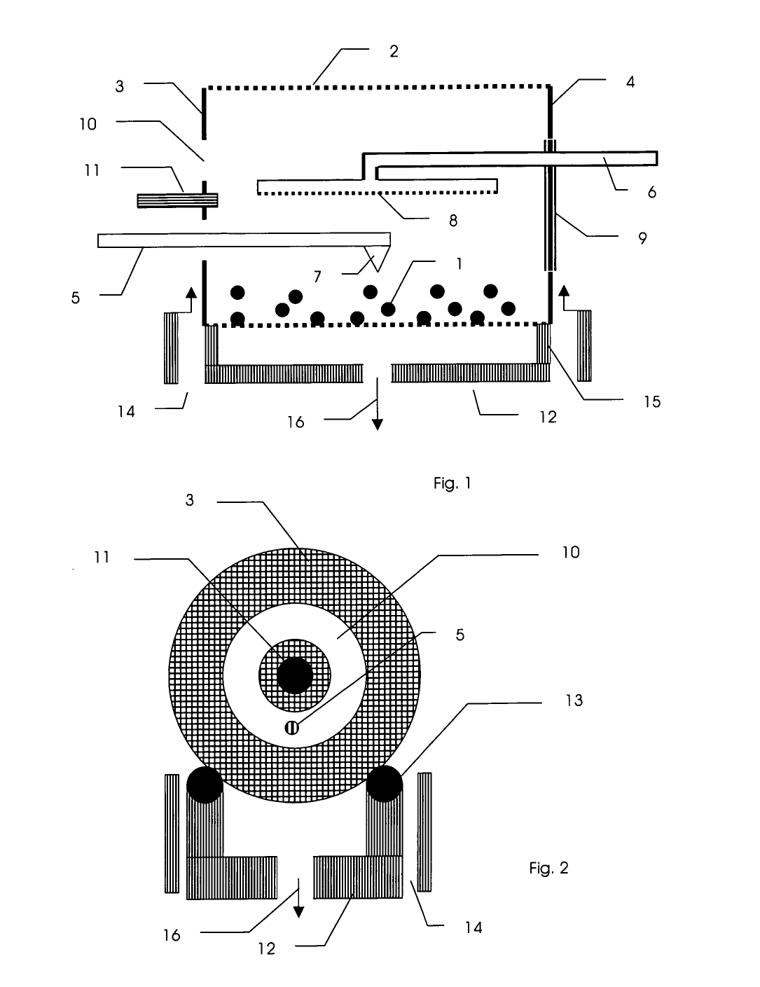

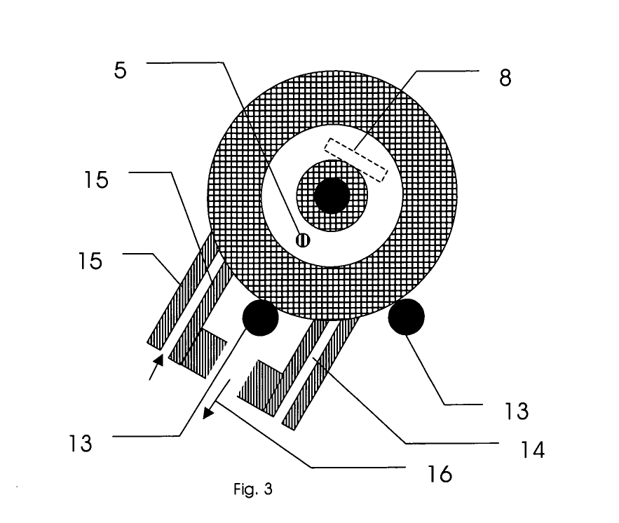

The invention is explained in more detail by means of the FIGS. 1 and 2.

FIG. 1 schematically shows a device according to the invention for coating tablets. The device comprises a drum provided with perforations 2 and having a front side 3 and rear 4. The drum is shown in cross-section in FIG. 1.

A first feed 5 for suspension takes place via the front side 3 of the drum. A second feed 6 for air takes place via the rear 4 of the drum. At its end, the feed of suspension is provided with at least one nozzle 7 in the interior of the drum. The suspension is discharged in a nebulized form through the nozzle 7 in the direction of the tablets 1 located in the drum. The air feed has at its end in the interior of the drum a punched plate 8 through which the fed air is discharged. The air stream is oriented in the same direction due to the punched plate 8, which may consist of a sheet metal (punched sheet), as well as a suitably selected flow rate. The nozzle 7 for feeding the suspension and the end with the punched plate 8 for the air feed are oriented downwards in the interior of the drum, i.e. in the same direction as the nozzle, towards the product bed, so that the discharged suspension reaches the tablets 1 as completely as possible. To achieve this aim, the end 8 of the air feed in the interior of the drum is arranged above the end 7 of the feed of the suspension.

The air feed into the interior of the drum takes place through a non-rotatably mounted circular plate 9, which is part of the rear 4 of the drum. The circular plate is provided with a borehole through which the feed or pipe 6 comes into the interior of the drum. The rest of the rear area 4 of the drum is rotatably connected with this circular plate 9. Neither this rest of the rear area 4, nor the circular plate 9 are perforated, in order to shield the rear space, and thus the production space. With the exception of the circular ring, the drum is rotated during the coating of the tablets 1. Electrical and other apparatuses of the device required for operation, such as, for example, means for warming the air, blowers for transporting air and/or suspension, driving means for rotating the drum, electrical and electronic control apparatuses for controlling the device and/or electrical closing means as well as other actuation means are, completely or at least for the most part, placed behind the rear, as seen from the interior of the drum. On the one side, this area is shielded due to the closed rear. The apparatuses are thus well protected and can easily be electrically shielded. The area in front of the rear 4, which serves production, then also remains clear or at least mostly clear of apparatuses that would otherwise interfere in a disadvantageous manner with the handling of the device by a human operator.

The front side has a circular opening 10 through which the feed 5 for the suspension comes into the interior of the drum.

The entire circumference of the drum can be perforated without having to accept the disadvantages relating to increased air feed known from the state of the art.

A suction device 12 is provided underneath the drum. The desired direction of the flow is maintained by it in an improved manner.

The suction device comprises a housing provided with two rotatably mounted castors 13, as is shown in FIG. 2. The drum is borne or placed on the castors 13. Thus, the castors 13 serve as a seal at the same time. In one embodiment, the castors can be rotated by means of motors. The motorized rotation of the drums can thus take place in a particularly simple manner, since another bearing can then be dispensed with. In that case, it is possible to guide the feeds 5 and 6 along the axis of rotation into the interior of the drum. Thus, the circular plate can be dispensed with in the case of the air feed, which can reduce production costs. Otherwise, the circular opening 10 can be dispensed with, which reduces the effort in construction and increases the utilizable volume.

The seal of the suction device protects the production space from soiling due to dried suspension brought out of the drum. The seal can be effected by suitable measures such as sealing lips, sealing strips or sealing rolls.

At its border, the suction device 12 has air feeds 14. They preferably border on the front side 3 and on the rear 4 of the drum. Thus, air curtains are formed bordering on the front side 3 and the rear 4. The air curtains shield the production space from dried suspension, that is, dust, which is discharged from the drum downwards through the perforation.

Additionally, sealing lips 15 bordering on the drum may be provided laterally at the border of the suction device, which shield the interior of the suction device further in an improved manner from the rest of the exterior in order not to soil the rest of the exterior.

The air with the dust that has been sucked off is disposed via a pipe 16 leading out of the housing.

However, the embodiment according to FIG. 2 does not yet take into account that the suspension and the air feed are advantageously directed downwardly, in order to thus take into account that, during operation, the tablets are located, on average, laterally next to the lowest point in the drum, that is, laterally in the direction of rotation of the drum. In one embodiment in which the air and the suspension flow obliquely towards the product bed, the suction device is preferably arranged in a correspondingly oblique manner, as can be gathered from FIG. 3. Then, the castors 13 only serve as supports. The castors are not basically capable of providing a seal in this embodiment, because at least one castor 13 is located outside the suction device, as a rule. The castors underneath the drum then only serve as support, not as seal.

The seal of the suction device can be effected in an easily sealing manner by means of a sealing lip 15. The sealing lip 15 then seals towards the inside, as is shown in FIG. 1. There is then a clear air discharge towards the outside of the drum. Two sealing lips may also border on the drum in place of a simple seal, as is suggested in the FIG. 3.

The punched plate 8, the nozzle, the normal of the product bed surface 17, and the outlet channel of the suction 16 are then preferably located on a common axis that runs obliquely (suggested in FIG. 3).

1. A device for coating tables with a drum provided with perforations which has a front side and a rear wherein a first feed for at least one of suspension of and air is provided via the front side and a second feed for at least one of air and suspension is provided through the rear.

2. The device according to claim 1, wherein the first feed comprises a feed for the suspension and takes place via the front side.

3. The device according to claim 1, wherein the feed for suspension is provided at an end in an interior of the drum with at least one nozzle.

4. The device according to claim 1 wherein the feed for air is provided at an end in an interior of the drum with at least one of a punched sheet and a punched plate.

5. The device according to claim 1 wherein an end of the feed of said at least one of suspension and air in an interior of the drum is directed downwards so that the direction of flow of said at least one of air and suspension encloses an angle of between 0° and 45° with the vertical and that air and suspension flow in the same direction.

6. The device according to claim 1 wherein an end of the feed of air in an interior of the drum is arranged, at least in part, above an end of the feed of suspension.

7. The device according to claim 1 wherein a feed of air into an interior of the drum takes place through a non-rotatably mounted circular plate, which preferably is part of the rear of the drum.

8. The device according to claim 1 wherein electrical apparatuses of the device are placed behind the rear as seen from an interior the drum.

9. The device according to claim 1 wherein an entire circumference of the drum is perforated.

10. The device according to claim 1 wherein a suction device is provided underneath the drum.

11. The device according to claim 10, wherein the suction device is provided with rotatably mounted casters on which the drum is placed.

12. The device according to claim 10 wherein the suction device has an air feed bordering on the front side of the drum and the rear of the drum.

13. A drum for the device according to claim 1 having an opening which is one of ring-shaped and circular on one side and a circular disc rotatably connected with the rest of the drum on the opposite side, the circular disk being provided with a borehole.

14. A suction device with a housing serving suction purposes for a device according to claim 1 having air feeds laterally next to the housing serving suction purposes.

15. A method for coating tablets comprising:
filling a drum with tablets,
feeding suspension into the interior of the drum via a pipe which is guided through the one side of the drum;
nebulizing the suspension in the interior of the drum;
warming and feeding air into the interior of the drum though another pipe guided through the other side of the drum;
rotating the drum during the feed of air and suspension; and
removing the coated tablets from the drum.

16. The device according to claim 2 wherein the feed for suspension is provided at an end in an interior of the drum with at least one nozzle.

17. The device according to claim 2 wherein the feed for air is provided at an end in an interior of the drum with at least one of a punched sheet and a punched plate.

18. The device according to claim 3 wherein the feed for air is provided at an end in an interior of the drum with at least one of a punched sheet and a punched plate.

19. The device according to claim 16 wherein the feed for air is provided at an end in an interior of the drum with at least one of a punched sheet and a punched plate.

20. The device according to claim 2 wherein an end of the feed of said at least one of suspension and air in an interior of the drum is directed downwards so that the direction of flow of said at least one of air and suspension encloses an angle of between 0° and 45° with the vertical and that air and suspension flow in the same direction.
